(19) United States
(12) Patent Application Publication
(10) Pub. No.: US 2026/0217469 A1
(43) Pub. Date: Jul. 30, 2026

(54) FOOD TRANSPORTER AND STAGING SYSTEM

(71) Applicant: CFA Properties, Inc., Atlanta, GA (US)

(72) Inventor: Nathaniel Hugh Cates, Sandy Springs, GA (US)

(21) Appl. No.: 19/461,829

(22) Filed: Jan. 28, 2026

Related U.S. Application Data
(60) Provisional application No. 63/750,430, filed on Jan. 28, 2025.

(51) Int. Cl. B65G 17/12; A47F 10/06; B65G 43/02; B65G 47/04; B65G 47/34

(52) U.S. Cl. CPC B65G 17/123; A47F 10/06; B65G 43/02; B65G 47/04; B65G 47/34; B65G 2201/0202; B65G 2203/0283

(57) ABSTRACT

A food transport system for a high-capacity drive-through restaurant includes a transport track configured to guide movement of food items, a plurality of baskets movably coupled to the transport track, a loading station configured to load food items onto the baskets, an unloading station configured to unload food items from the baskets, an offload conveyor positioned adjacent to the unloading station, and a plurality of trays configured to be removably placed within the baskets for transporting food items along the transport track. The system enables efficient movement of food orders between different levels or areas of the restaurant. The loading station can include a grate for supporting trays as they are loaded, while the unloading station can transfer trays to the offload conveyor for order assembly and delivery.

### CROSS-REFERENCE TO RELATED APPLICATIONS

This application claims priority to US Provisional Patent Application No. 63/750,430, filed January 28, 2025, the contents of which are hereby incorporated herein in its entirety by reference.

### FIELD OF INVENTION

The present disclosure relates to food transporter systems for restaurants, and more particularly to a multi-level food transport system for efficiently moving prepared food orders from a kitchen to a drive-through service area and staging orders for finalization and presentation to customers.

### BACKGROUND

The restaurant industry has experienced significant shifts in consumer behavior and preferences in recent years. Demand for drive-through restaurant service has greatly increased, with customers seeking convenient and efficient ways to obtain their meals. Simultaneously, there has been a growing trend of customers ordering food ahead through mobile applications, either for personal pickup or delivery via third-party services. This shift has created a substantial demand for high-volume order processing, particularly during peak times such as the lunch hour, with popular restaurants facing especially high traffic.

As the desire for drive-through and delivery options has surged, there has been a corresponding decrease in demand for traditional dine-in restaurant experiences. In response to these changing preferences, a new model of high-capacity restaurants has emerged. These establishments prioritize high throughput for drive-through and delivery orders, often eliminating the dining room entirely. These restaurants feature a large, high-capacity kitchen on the second floor, with multiple drive-through lanes on the ground floor to accommodate the increased volume of orders.

This new restaurant model presents unique challenges, particularly in efficiently transporting a high number of food orders from the second-floor kitchen to the ground-floor pickup area. To address this need, some high-capacity drive-through restaurants have implemented automated food transport systems to transfer orders between floors. However, these existing systems often have limitations regarding the stability of the food products being transported. Published transporters in this field include US Patents 11,225,380 and 12,172,842, and US Publications 2024/0083684, 2024/0083683 and 2024/0409317, all of which are incorporated by reference in their entireties.

Trays have been used in restaurants to make it easier to carry food orders, such as from an order counter to a table. The use of trays can offer several advantages include the ability to carry multiple food bags or containers, while maintaining stability of the food orders. This in contrast to bags which may tip over if not carried carefully. Despite these potential benefits, current automated food transport systems in high-capacity drive-through restaurants have not effectively incorporated tray-based solutions.

As the restaurant industry continues to evolve to meet changing consumer demands, there is a growing need for innovative solutions that can enhance the efficiency and reliability of food transport in high-capacity drive-through establishments. Addressing the challenges of high-volume order processing and developing improved methods for moving food orders between different levels of a restaurant structure remain important areas for advancement in the field.

### SUMMARY

This summary is provided to introduce a selection of concepts in a simplified form that are further described below in the detailed description. This summary is not intended to identify key features or essential features of the claimed subject matter, nor is it intended to be used as being determinative of the scope of the claimed subject matter.

The present disclosure relates to a food transport system for a restaurant and a method of transporting food items in a restaurant. The system includes a transport track, baskets, loading and unloading stations, an offload conveyor, and trays. The method involves loading food items onto trays, transporting them via baskets on a track, and unloading them onto an offload conveyor, which facilitates food order staging, fulfillment and presentation to drive-through customers. Various aspects of the system and method aim to improve efficiency and automation in food handling and delivery within a restaurant setting.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a perspective view of a high-capacity drive-through restaurant, according to aspects of the present disclosure.

FIG. 2 illustrates a cutaway view of the high-capacity drive-through restaurant of FIG. 1, according to an embodiment.

FIG. 3 illustrates an isometric view of a food transporter system, according to aspects of the present disclosure.

FIG. 4 illustrates a close-up view of a portion of a food transporter system, according to an embodiment.

FIG. 5 illustrates a perspective view of a loading station for the food transporter system, according to aspects of the present disclosure.

FIGS. 6A-B illustrate perspective views of the loading station of FIG. 5, according to an embodiment.

FIG. 7 illustrates another perspective view of a loading station, according to aspects of the present disclosure.

FIG. 8 illustrates a perspective view of an unloading station for the food transporter system, according to an embodiment.

FIG. 9 illustrates another perspective view of an unloading station, according to aspects of the present disclosure.

FIGS. 10A-B illustrate perspective views of the food transporter system in operation, according to an embodiment.

FIG. 11 illustrates a perspective view of a food delivery and drink station staging area, according to aspects of the present disclosure.

FIGS. 12A-C illustrate perspective views showing operation of an empty tray unload station, according to an embodiment.

FIG. 13 illustrates a perspective view of an example path for the transport track of the food transporter system, according to aspects of the present disclosure.

FIGS. 14A-C illustrate perspective views showing operation of the unloading station and an offload conveyor showing an empty tray unload station, according to an embodiment.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

In some aspects, the system may include mechanisms for managing empty trays. This may involve automatically stacking empty trays in carts and/or returning empty trays to the e transporter system.

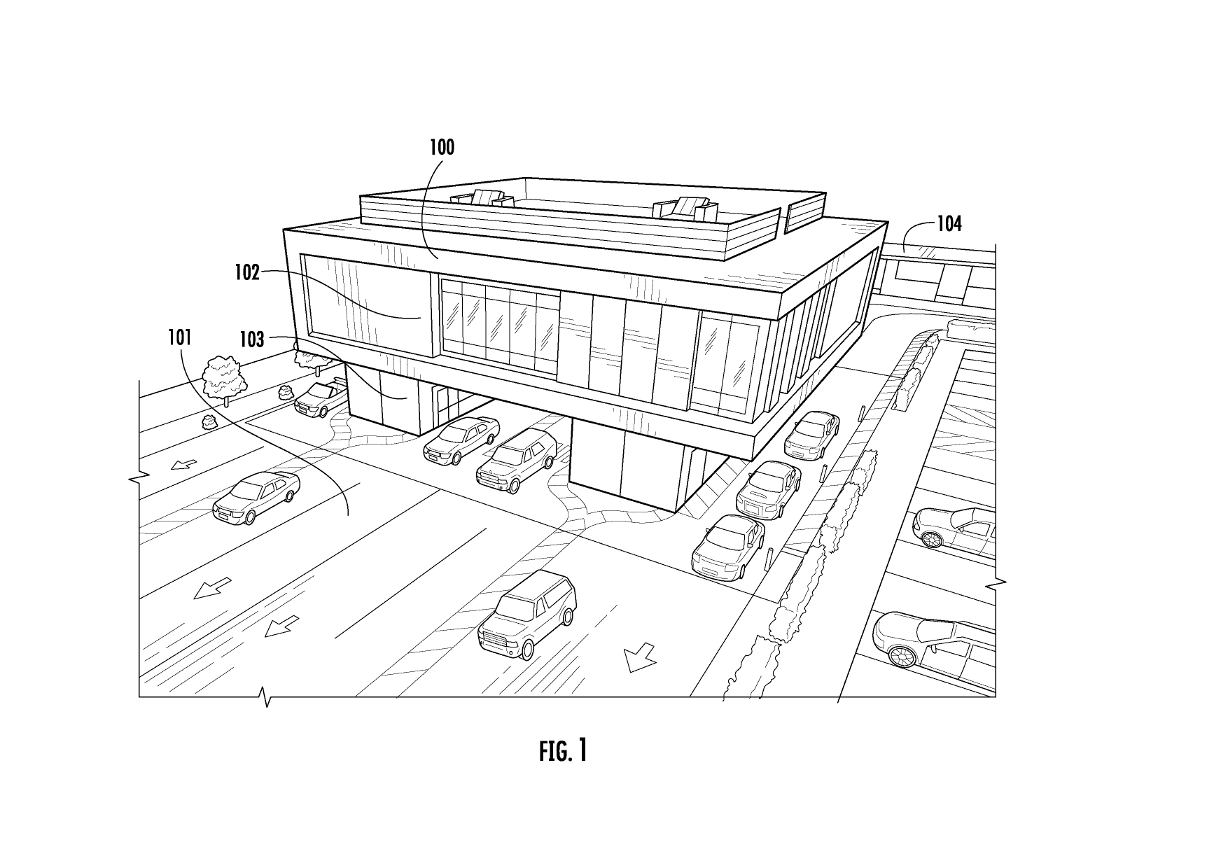

Referring to FIG. 1, a high-capacity drive-through restaurant 100 may be provided. In some aspects, the restaurant 100 may comprise a two-story structure with a second floor 102 and a ground floor 103. The second floor 102 may house the kitchen, while the ground floor 103 may accommodate multiple drive-through lanes 101.

The drive-through lanes 101 may be visible on the ground floor 103, with multiple lanes allowing for increased capacity. In some implementations, vehicles may be queued in these lanes. Directional arrows may be painted on the pavement to guide traffic flow through the drive-through lanes 101. Multiple pull over lanes may be provided for a customer to await a delayed order while other customers can continue through the drive-through.

In some cases, an ordering station 104 may be provided in the drive-through area. The ordering station 104 may be positioned where customers place their orders before proceeding to the pickup windows. In some aspects, the ordering station 104 may be a standalone structure separate from the main building of the restaurant 100. Some of the lanes in the ordering station 104 may be traditional drive-through lanes where customers speak with a team member through a speaker box to place their order. Other lanes may be dedicated app ordering lanes, where only customers who have preordered their food through the restaurant's app may drive. Still other lanes may be dedicated delivery driver lanes. For the dedicated lanes, no speaker box may be provided, and the customer or delivery driver can drive straight through or around the ordering station 104.

The surrounding area of the restaurant 100 may include a parking lot with spaces for additional vehicles such as cars belonging to restaurant's team members, and service areas for deliveries, trash pick-up, external restrooms and the like.

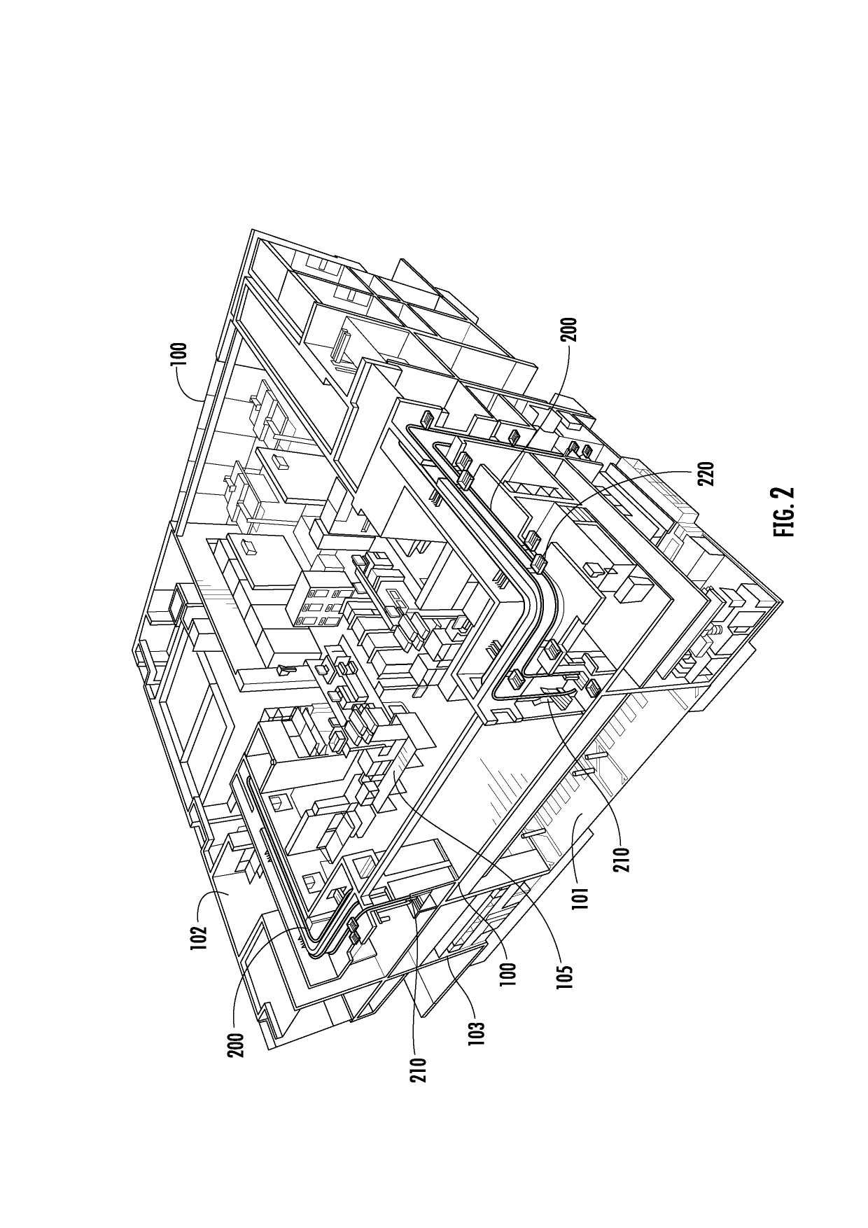

Referring to FIG. 2, a cutaway view of the high-capacity drive-through restaurant 100 is illustrated. In some aspects, the restaurant 100 may comprise a two-story structure with a second floor 102 and a ground floor 103. The second floor 102 may house the kitchen 105, while the ground floor 103 may accommodate the drive-through lanes 101. The overall design of the high-capacity drive-through restaurant 100 may prioritize efficiency and high-volume service. The multi-lane drive-through system on the ground floor 103 and the two-story structure with the kitchen on the second floor 102 may contribute to this efficiency. In some aspects, this configuration may allow for separation of food preparation and order delivery processes, increasing the overall throughput of the restaurant 100.

A food transporter system 200 may include a transport track 210 that extends from the second floor 102 to the ground floor 103. The transport track 210 may be configured to carry baskets 220 containing food orders on trays from the kitchen 105 to the ground floor 103.

In some cases, an elevator may be provided to allow team members to move between the ground floor 103 and the second floor 102. The elevator may also facilitate the return of full tray carts to the kitchen 105 on the second floor 102 as described further below.

The drive-through lanes 101 may pass through the middle of the structure and on each side of the restaurant 100. This configuration allows for efficient traffic flow and increased capacity for serving customers.

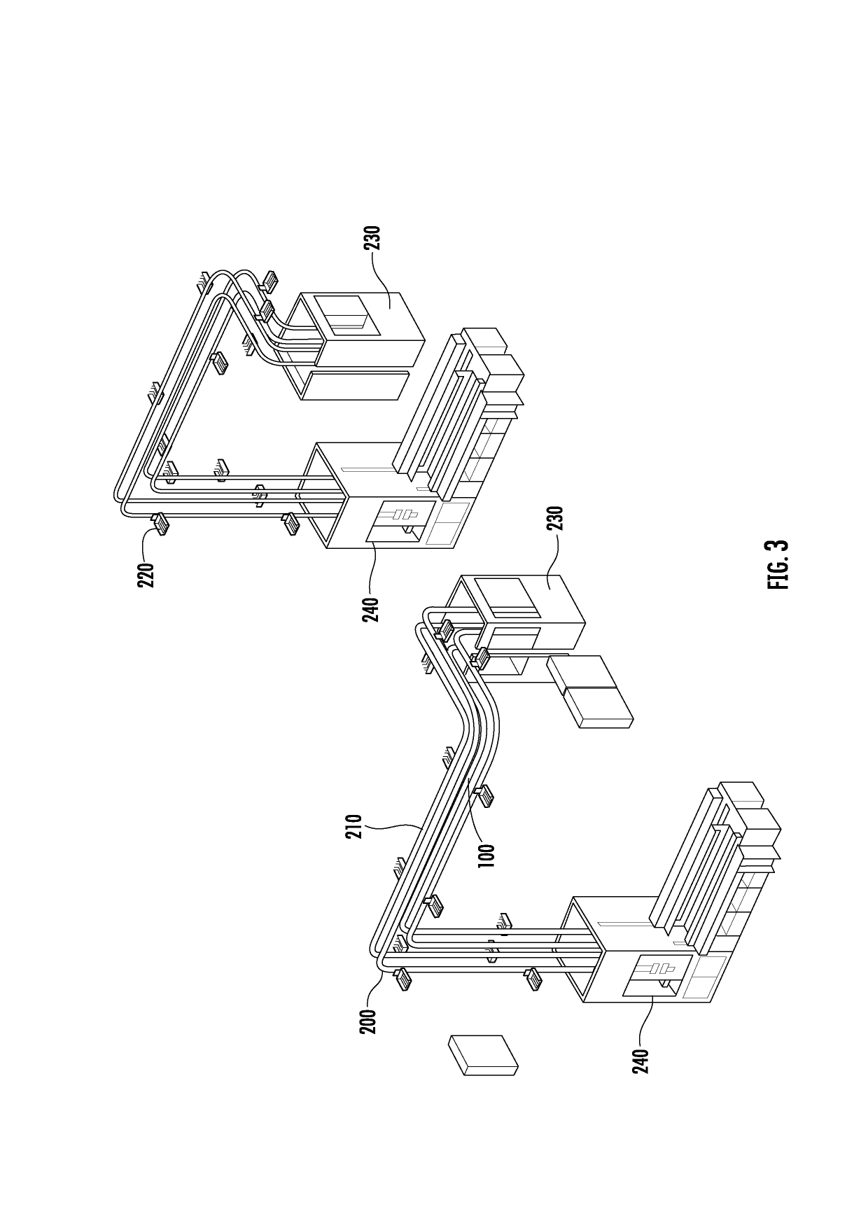

An unloading station 240 (see FIG. 3) may be positioned on the ground floor 103 at the end of the transport track 210. The unloading station 240 may be configured to receive baskets 220 supporting food orders from the food transporter system 200 and facilitate the distribution of orders to customers in the drive-through lanes 101.

The layout of the restaurant 100 may be designed to optimize the flow of food preparation on the second floor 102 and order delivery on the ground floor 103. The food transporter system 200 may serve as a link between the kitchen 105 and the customer service area, enabling efficient transfer of prepared orders from the upper level to the lower level. This design may allow for a separation of food preparation and order delivery processes, potentially increasing the overall efficiency of the high-capacity drive-through restaurant 100.

Referring to FIG. 3, the food transporter system 200 is illustrated in isolation. In some aspects, the food transporter system 200 may comprise several components designed to facilitate the movement of food items between different levels or areas of a structure.

The food transporter system 200 may include a transport track 210, which may form the primary pathway for food transportation. In some cases, the transport track 210 may create a continuous loop-like structure that traverses multiple levels and directions. However, the particular configuration of the transport track 210 may depend on the layout of the restaurant. In some implementations, the transport track 210 may traverse multiple floors, while in other cases, it may be confined to a single floor. For example, in an urban format restaurant, the kitchen may be located in a basement level, and the transport track 210 may be configured to move food items from the basement kitchen to a ground-level service area.

Baskets 220 may be attached to the transport track 210 at regular intervals. These baskets 220 may be designed to carry food items through the system. In some aspects, the baskets 220 are configured to accommodate trays or other containers holding prepared food orders.

The food transporter system 200 may include loading stations 230 and unloading stations 240. The loading stations 230 may be positioned at one end of the transport track 210, where food items may be placed into the baskets 220. The unloading stations 240 may be located at the opposite end of the track, where food items may be removed from the baskets 220 for delivery or further processing.

In some implementations, a restaurant such as the one shown in FIG. 1 may include two food transporter systems 200. This configuration may allow for increased capacity and flexibility in food transportation. Depending on the restaurant's operational needs, one or both systems may be in operation at any given time. The food transporter system 200 may be designed to handle high volumes of transactions, potentially processing up to 720 transactions per hour or more in some implementations. However, during periods of lower demand, only one food transporter system 200 may be active, while both systems may be utilized during peak hours to handle higher volumes of orders.

The overall design of the food transporter system 200 may allow for efficient vertical and horizontal movement of food items, potentially bridging different floors or sections of a building. The continuous loop design of the transport track 210 may enable empty baskets 220 to be returned to the loading stations 230 after unloading, facilitating a continuous cycle of food transportation.

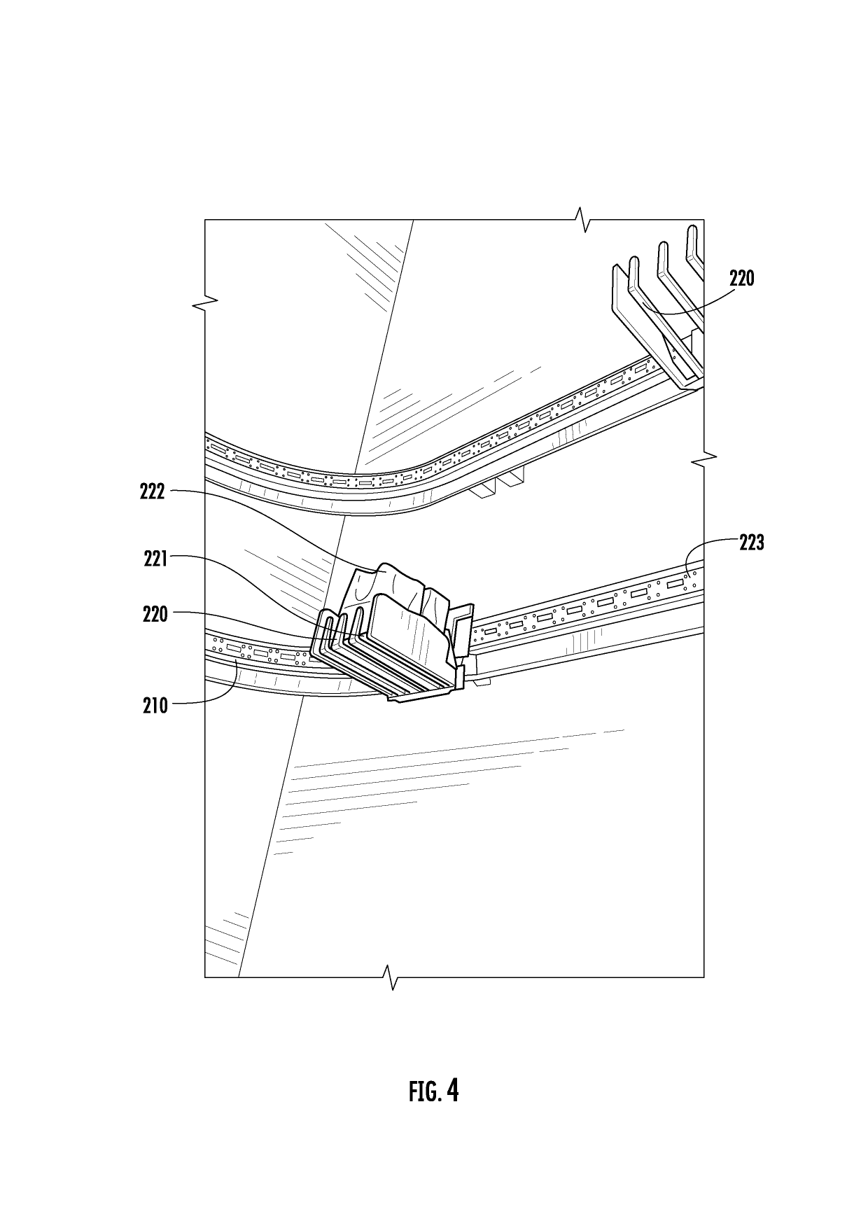

Referring to FIG. 4, a close-up view of a portion of the food transporter system 200 is illustrated. In some aspects, the food transporter system 200 may comprise several components designed to work together to facilitate efficient food transport.

The transport track 210 is a rail-like structure that guides the movement of the basket 220. In some implementations, the transport track 210 may feature curved sections, which may allow the system to change direction, potentially to navigate between different levels or areas of a building.

A basket 220 is attached to travel along the transport track 210. The basket 220 may be designed to hold and transport food items through the system. In some cases, the basket 220 may be configured to accommodate a tray 221 supporting a food bag 222, providing a secure platform for transporting prepared orders. The use of trays is advantageous over conventional food transport systems that use clips circulating around a track, wherein the clips are designed to secure bags containing food orders. For example, the clips require operation by an employee to engage each bag at a loading point and disengage them at an offloading point. The clips also may not securely engage some food bags, such as thin gauge paper bags or plastic bags. Finally, the bags cannot securely support within them certain food items, such as bowls of soup and cups of drinks, without the possibility of leakage. With the use of trays, the loading and unloading requires less team member engagement, the trays can support thin gauge paper or plastic bags, and the trays can support soups or drinks. Finally, the trays allow multiple food bags and other items to be carried together, thus allowing multiple different customer orders to be transported on a single tray and improving efficiency over conventional clip systems.

Within the transport track 210, a chain 223 may be positioned, although other tensile members such as cables may be alternatively or additionally used. The chain 223 may run within the fixed transport track 210 and may be connected to the baskets 220. As the chain 223 travels through the transport track 210, it may move the baskets 220 with it. This configuration may allow for continuous and controlled movement of food items throughout the system. Each basket 220 may be removable from the chain 223 so that it may be cleaned should any food item spill onto the basket.

In some implementations, the chain 223 may be driven by one or more electric motors. While not shown in FIG. 4, these motors may be positioned at one or more points along the transport track 210 to provide the necessary power for moving the chain 223 and attached baskets 220.

The overall design of the system provides a continuous loop configuration, where baskets 220 can move along the transport track 210, including through curved sections, to efficiently transport food items between different areas of a facility. This arrangement may allow for flexible routing of food orders, potentially accommodating various restaurant layouts or operational needs.

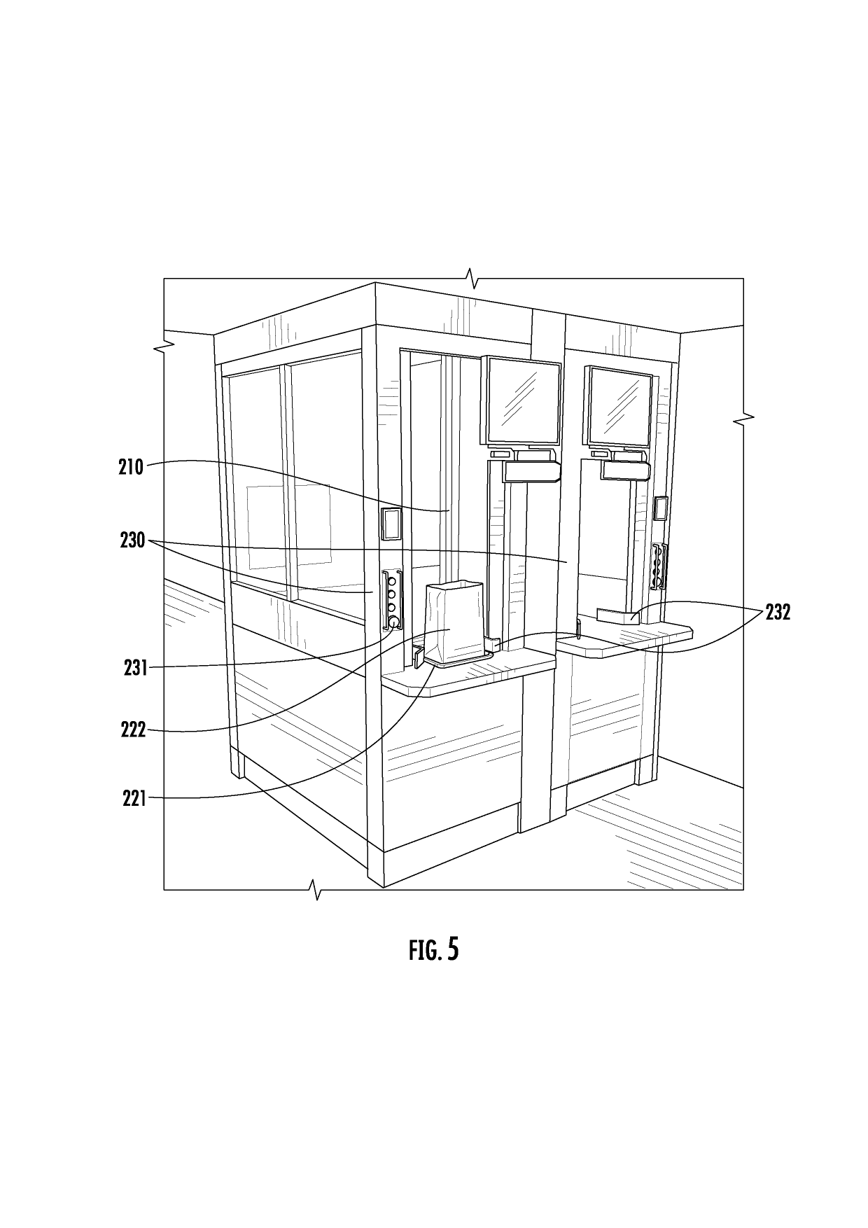

Referring to FIG. 5, a loading station 230 for the food transporter system 200 may be provided. In some aspects, the loading station 230 may comprise a booth-like structure with a counter and enclosed sides. The transport track 210 may enter the loading station 230, indicating where baskets 220 would travel along the system. in the illustrated configuration, the chain and the baskets 220 move vertically upwardly.

In some implementations, two loading stations 230 may be provided, each corresponding to one of the transport tracks 210 shown in FIG. 3. This configuration may allow for increased loading capacity and operational flexibility.

The loading station 230 may include loading station controls 231, which may comprise various buttons and indicators to manage the loading process. In some cases, these controls may include an emergency stop button, allowing operators to quickly halt the system if necessary.

Tray guides 232 may be mounted on the counter of the loading station 230. These tray guides 232 may be designed to assist team members in guiding trays 221 into the loading station 230 and centering them therein. In some implementations, the tray guides 232 may be adjustable to accommodate different tray sizes or configurations.

The loading station 230 may be designed to facilitate the efficient loading of food items onto trays 221 and into baskets 220. In some cases, team members may place prepared food orders onto trays 221, which may then be guided into the loading station 230 using the tray guides 232. As noted, each tray may include one or more food orders and can also support liquid containers such as soup bowls. The baskets 220 may then move upwardly through the loading station 230 to carry away the loaded trays 221 as discussed in more detail below.

The integration of the transport track 210 with the loading station 230 may allow for seamless movement of baskets 220 through the loading process. In some aspects, sensors may be incorporated into the loading station 230 to detect when a tray 221 is properly positioned for loading, potentially triggering the movement of a basket 220 into position. Further, sensors may be incorporated into the walls of the loading station 230 that can sense when a tray and/or a team member’s hand is extending into the loading station, which can then stop or slow the chain to avoid spillage or injury.

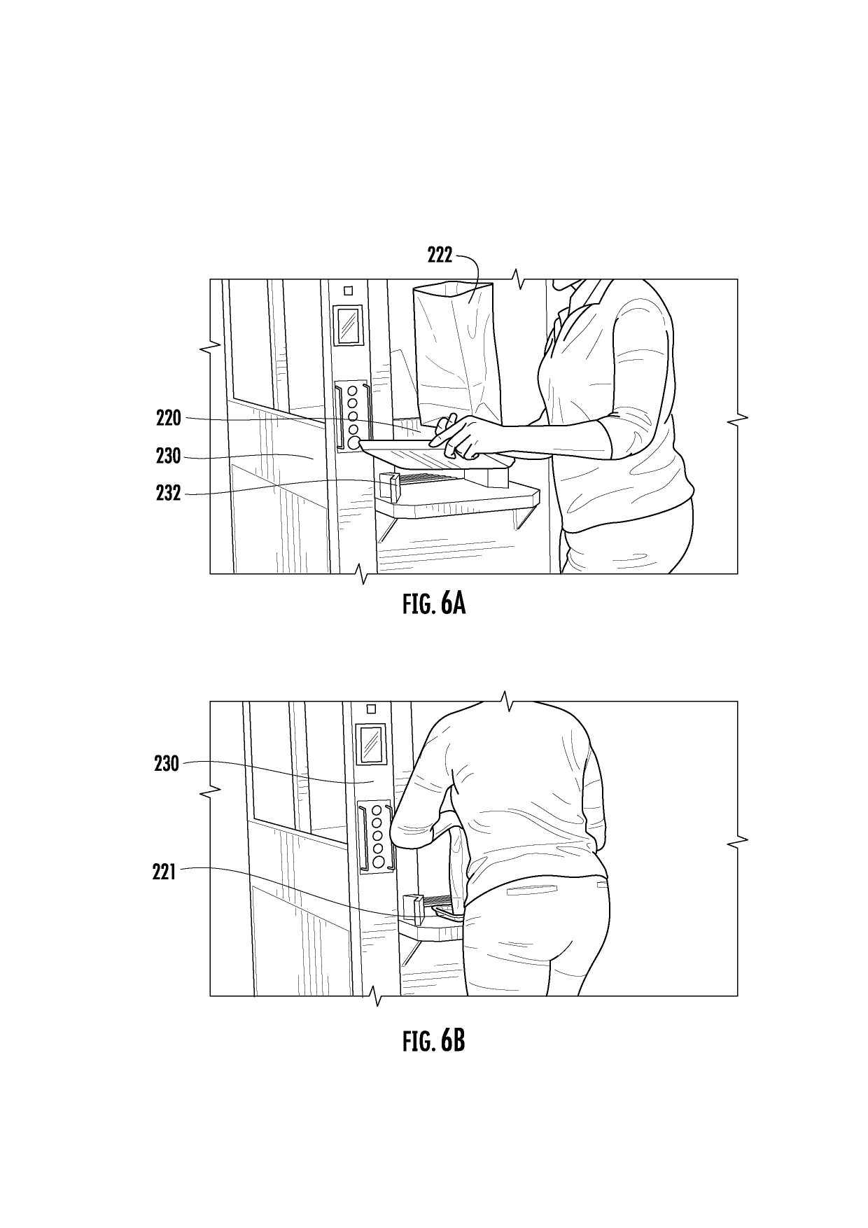

Referring to FIGS. 6A-B, detailed views of the loading station 230 for the food transporter system 200 may be provided. In some aspects, the loading station 230 may comprise a booth-like structure with a counter and enclosed sides, designed to facilitate efficient loading of food items onto trays 221 and into baskets 220.

In FIG. 6A, a basket 220 is shown within the loading station 230 as having just picked up a tray 221. The basket 220 may be designed to hold food items for transport and may be configured to move a food bag 222 upwardly on a tray. In some implementations, the food bag 222 may contain a customer's prepared food order. Although shown with only one bag, the tray could be loaded with more than one bag, drinks and/or accessories such as utensils, condiments straws and promotional items such as toys.

FIG. 6B shows a view of the loading station 230 during the loading process. A team member is shown placing a tray 221 into the loading station 230. The tray 221 may be guided into position using the tray guides 232 (FIG. 6A).

The loading process may involve team members placing prepared food orders onto trays 221, which may then be guided into the loading station 230 using the tray guides 232. In some implementations, once a tray 221 is properly positioned, a basket 220 may move upwardly through the loading station 230 to carry away the loaded tray 221.

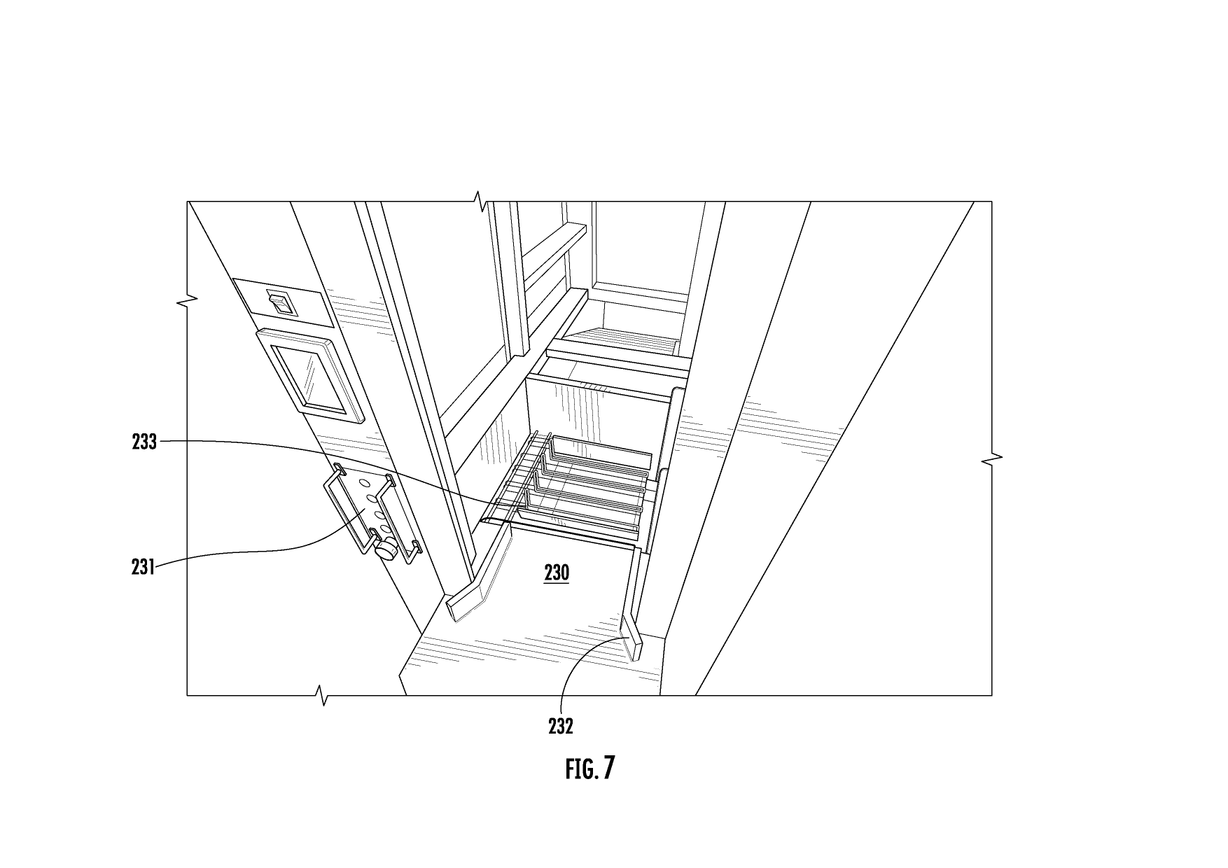

Referring to FIG. 7, a detailed view of the loading station 230 for the food transporter system 200 may be provided. In some aspects, the loading station 230 may comprise a booth-like structure with enclosed sides and an open front area. The structure may house several components designed to facilitate the efficient loading of food items onto trays and into baskets.

At the bottom of the loading station 230, a loading station grate 233 is secured. The loading station grate 233 may be composed of parallel metal bars and may be designed to support a tray 221 while it awaits a basket 220 to transport it through the system. In some cases, the spacing between the metal bars of the loading station grate 233 may be configured to allow a basket 220 to move through the grate from underneath.

The loading process may involve a team member pushing a loaded tray 221 onto the loading station grate 233. The tray 221 may rest on the grate, supported by the parallel metal bars, while awaiting a basket 220 to move up from underneath.

The baskets used in the food transporter system 200 may comprise multiple separate elongate members that are configured to fit between the bars of the loading station grate 233. This design may allow the basket 220 to move vertically through the grate and pick up a tray 221 resting on the grate. As the basket 220 moves upward, its elongate members may pass between the parallel bars of the loading station grate 233, lifting the tray 221 and its contents.

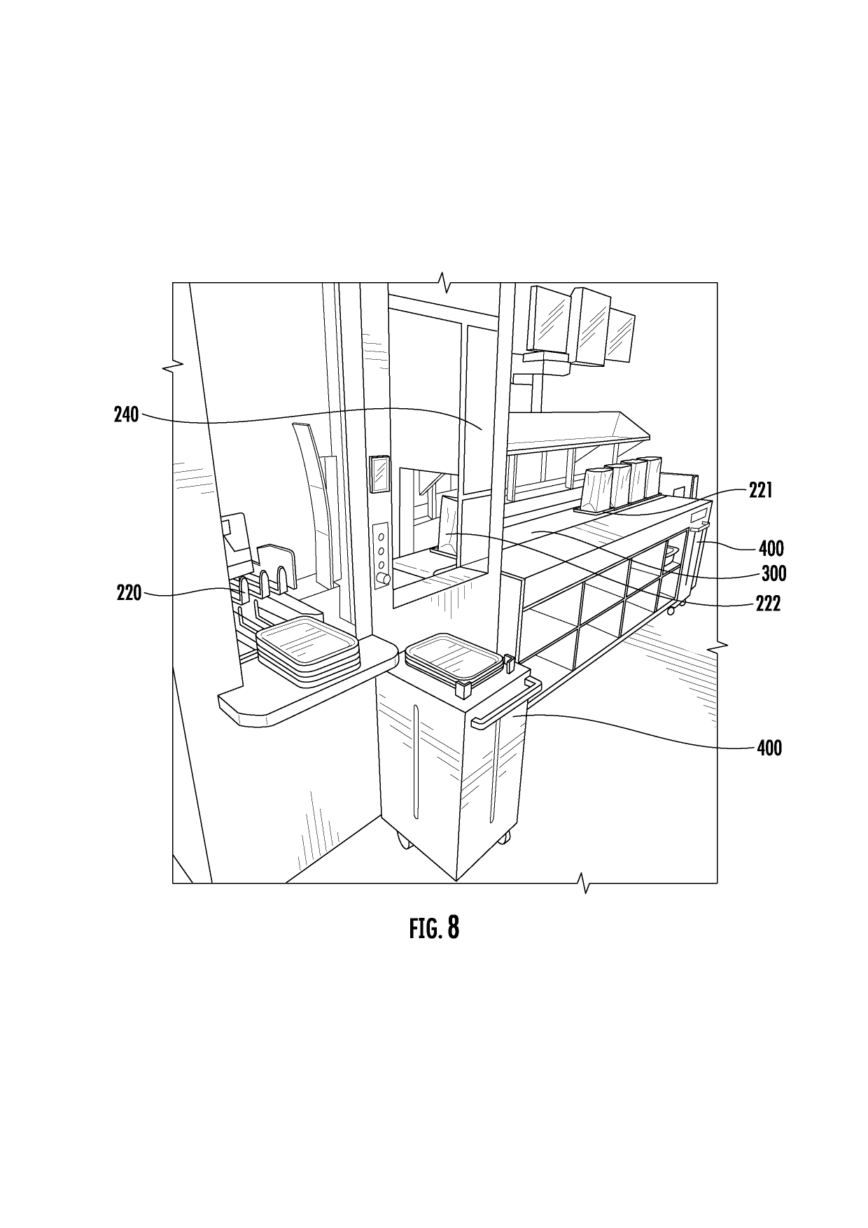

Referring to FIG. 8, an unloading station 240 for the food transporter system 200 may be provided. In some aspects, the unloading station 240 may comprise several components designed to facilitate the unloading and distribution of food items.

In the unloading station 240 shown, a basket 220 moves downwardly from above with a tray 221 supported thereon. As the basket 220 moves through the unloading station 240, the tray 221 may be deposited onto an unloading station grate 241.

An offload conveyor 300 may extend from the unloading area and may be designed to move trays along its length. In some aspects, the offload conveyor 300 may include multiple sections, which correspond to various stages of the unloading process. For example, one section may be dedicated to receiving trays 221 from the baskets 220, while another section may be used for staging orders for pickup. Yet another section may be used for offloading empty trays, as discussed in more detail below. These sections may comprise a plurality of adjoining conveyor belts that move trays from one conveyor belt to another in sequence, or may comprise a single conveyor belt that moves from section to section. The conveyor belt(s) may selectively stop at one or more locations to allow the receiving of trays, staging of orders, and/or offloading of empty trays.

A tray cart 400 may be provided in the unloading station 240. In some aspects, multiple tray carts 400 may be present at different locations within the unloading station 240. One tray cart 400 may be positioned at the end of the offload conveyor 300. This cart 400 may be designed for collecting empty trays 221 after team members have removed the food bags 222 for hand delivery to customers in their vehicles. In some implementations, the empty trays 221 may be deposited directly onto the tray cart 400 from the conveyor 300, allowing for efficient management of empty trays. The tray carts 400 may be provided with a spring-loaded magazine structure inside that can allow for a number of trays, such as 100 trays, to be supported within the tray cart. As each tray is loaded into the magazine, the weight of the tray causes a support platform (not shown) to sink lower into the tray cart. This weight is opposed by one or more springs acting upwardly against the support platform. Thus, as the trays are loaded, an opening may be provided at the top of the tray cart to allow at least one more tray to loaded therein, at least until the tray cart is full. A sensor inside the tray cart may alert the system that the tray cart is full, and may shut down the offload conveyor and/or the baskets 220 until a team member replaces the full cart with a more empty one. In addition, sensors at the end of the offload conveyor may sense the presence of a tray cart in the correct position to receive trays, and provide alerts and/or pause the offload conveyor and/or the baskets 220 until a team member places a tray cart in the correct position to receive empty trays.

Another tray cart 400 may be located in a different area of the unloading station 240, potentially for storing additional empty trays 221 or for use in other stages of the unloading process. The presence of multiple tray carts 400 may allow for flexible tray management and may help maintain a smooth workflow in the unloading station 240.

The overall layout of the unloading station 240 may be designed to focus on efficiency in the food unloading, staging, fulfillment and distribution process. The arrangement of components may allow for a smooth transition of food items from the baskets 220 to the offload conveyor 300, with provisions for tray management via the tray carts 400. According to an embodiment, empty trays may be returned to adjacent the loading station by returning on an empty basket of the transport track’s return path. As shown in FIG. 8, a tray cart 400 is shown adjacent to the unloading station 240. This tray cart may contain a number of trays that have previously delivered food orders and have been stacked therein as discussed above. A team member can then remove at least a portion of the trays, such as 5 trays, and place them into an empty basket returning upwardly to the loading station 230. This process is continued until the tray cart 400 is emptied, thus returning trays to second floor for reuse and allowing the tray cart 400 to be rolled to the end of the offload conveyor 300 ready to receive more trays. Advantageously, this process allows for efficient return of the trays and can occur simultaneously with full trays moving down into the unloading station 240.

In addition or in the alternative, full tray carts 400 may be returned from the ground floor 103 to the second floor 102 by way of the team member elevator. The tray carts 400 may also be used to roll trays to a cleaning station (not shown) for cleaning the trays before reuse.

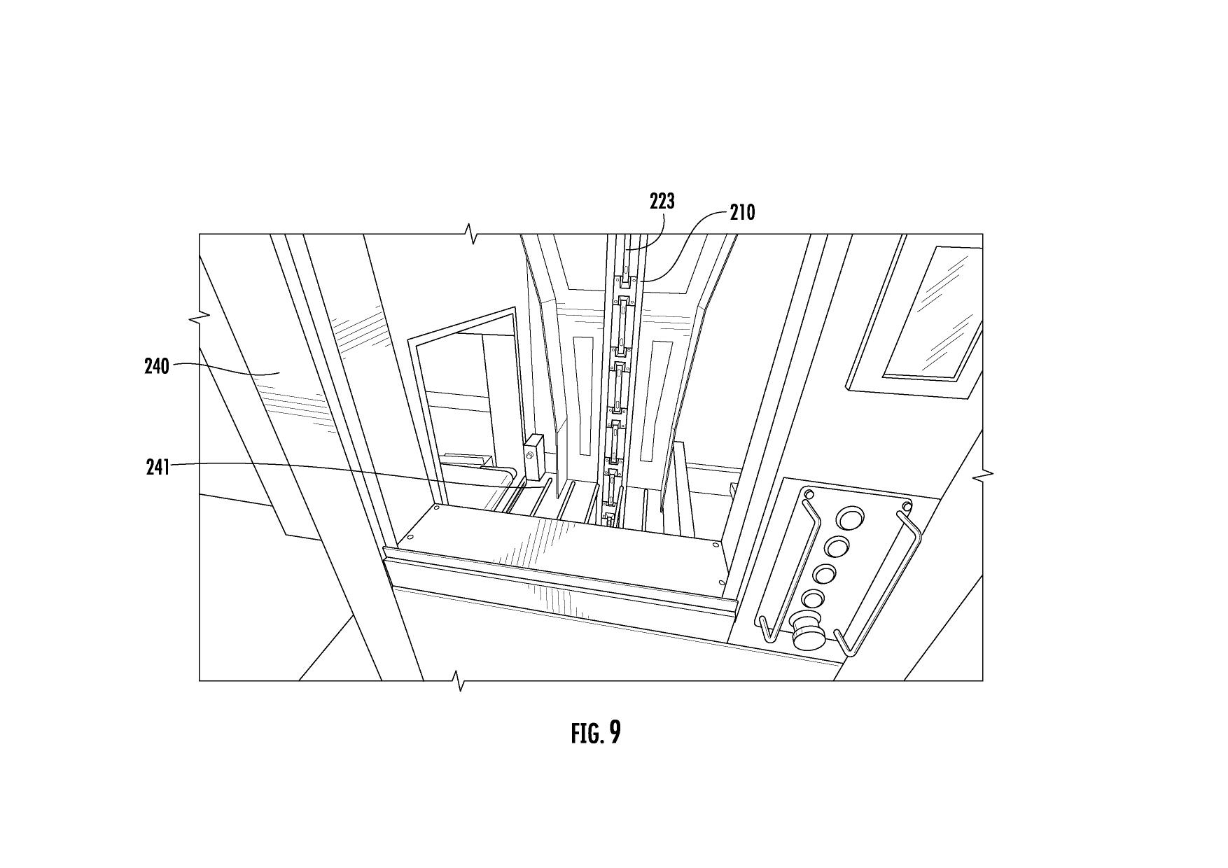

Referring to FIG. 9, an unloading station 240 for the food transporter system 200 may be provided. In some aspects, the unloading station 240 may comprise a booth-like structure with transparent panels, allowing visibility of the internal components and facilitating the unloading process.

The transport track 210 may run vertically through the center of the unloading station 240. This transport track 210 may serve as the primary guide for the movement of food items through the system. Movably positioned within the transport track 210 is the chain 223, which moves baskets along the transport track 210.

At the bottom of the unloading station 240, an unloading station grate 241 may be provided. The unloading station grate 241 may consist of parallel metal bars and may serve as a platform for unloading food items from the transport system. In some implementations, the spacing between the metal bars of the unloading station grate 241 may be configured to allow baskets to move through the grate from above.

The unloading process may involve baskets moving downward through the unloading station 240. As a basket approaches the unloading station grate 241, it may pass through the parallel bars, depositing the tray 221 and its contents onto the grate. This design may allow for a smooth transition of food items from the transport system to the next stage of food handling or delivery. The individual times of the basket may be connected to a main portion of the basket by way of a pivotable arrangement. As such, if a basket were to strike something along its path of travel, the tines can fold out of the way to reduce or avoid damage or injury.

The unloading station grate 241 may be fitted with parallel rollers, one or more of which may be powered to rotate so as to move the trays laterally from the grate to the offload conveyor 300. Alternatively or additionally, the unloading station grate 241 may be sloped at a slight angle to allow the trays to roll or slide under the force of gravity onto the offload conveyor 300. Alternatively or additionally, the unloading station grate 241 may be vertically aligned with the belt of the offload conveyor 300 so that at least one edge of each tray being deposited onto the grate is simultaneously deposited onto an initial portion of the belt. In this fashion, as the conveyor belt is advanced, the tray is pulled from the unloading station grate and thereafter fully supported by the offload conveyor. This allows for a “set and forget” arrangement where the team member can load a food order upstairs at the loading station, and no further team member interaction is needed until a food order reaches the end of the offload conveyor. Depending on restaurant configuration, the entire trip may take no longer than 30 seconds.

The unloading station 240 may feature various control elements. These controls may facilitate the operation of the unloading process. In some cases, the control panel may include buttons for adjusting the speed of the transport system, emergency stop functions, or indicators for system status. An emergency stop button may be provided here also.

In some implementations, sensors may be incorporated into the unloading station 240 to detect when a tray 221 has been successfully deposited onto the unloading station grate 241. These sensors may trigger subsequent actions, such as alerting team members that an order is ready for pickup or initiating the movement of the empty basket 220 back through the system.

The transparent panels of the unloading station 240 may serve multiple purposes. They may allow team members to visually monitor the unloading process, facilitate troubleshooting if issues arise, and potentially contribute to food safety by maintaining a controlled environment during the unloading process.

In some aspects, the unloading station 240 may be designed with ergonomics in mind. The height of the unloading station grate 241 and the overall layout of the station may be optimized to reduce strain on team members who are retrieving food items for delivery to customers.

The overall design of the unloading station 240 may enable efficient transfer of food items from the transport system to the next stage of food handling or delivery. The integration of the transport track 210, chain 223, unloading station grate 241, and control elements may work together to create a seamless unloading process, potentially contributing to the overall efficiency of the food transporter system 200.

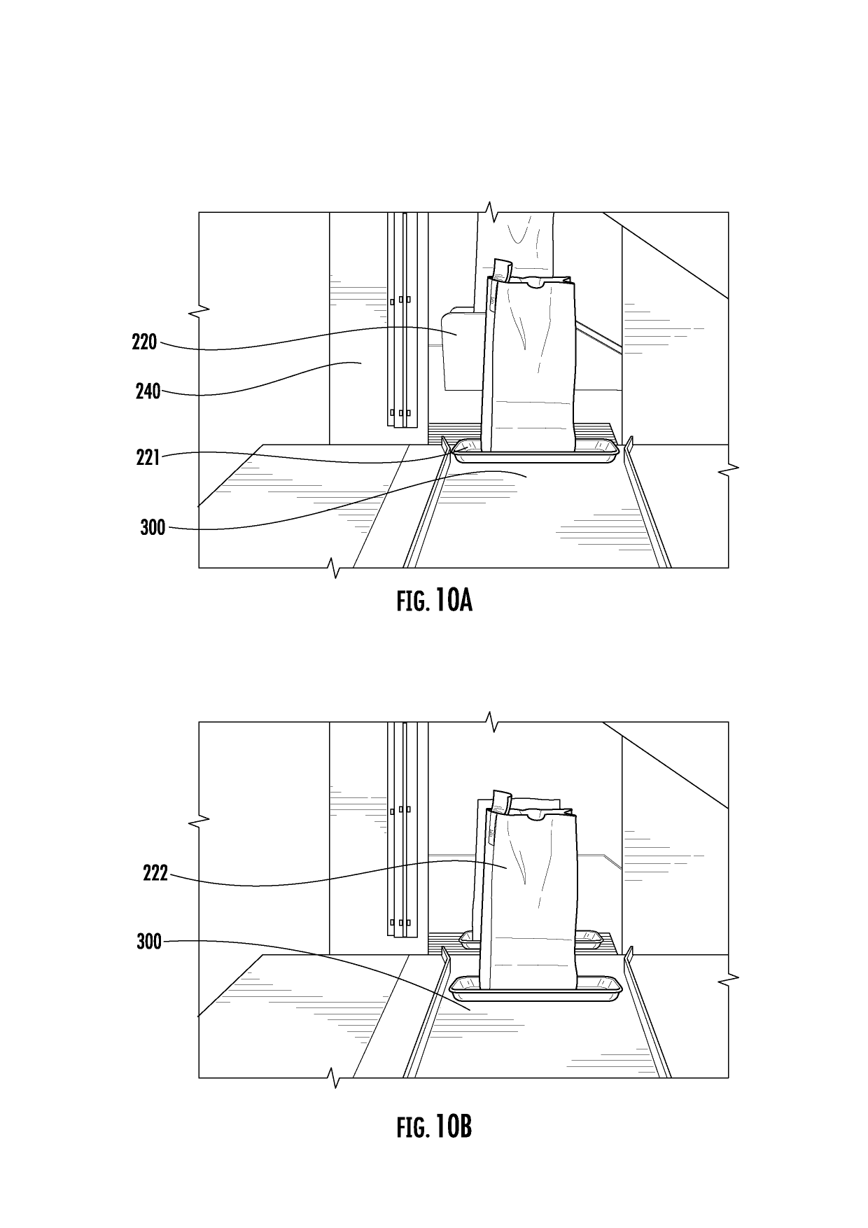

Referring to FIGS. 10A-B, the operation of the food transport system as it transfers food items from the unloading station 240 to the offload conveyor 300 is illustrated. In some aspects, the process may involve the movement of a basket 220, tray 221 and food bag 222 thereon through various stages of the unloading procedure.

In FIG. 10A, a basket 220 is shown moving downwardly within the unloading station 240. The basket 220 is supporting a tray 221 carrying a food bag 222 containing a prepared food order. As the basket 220 descends, it may approach the unloading station grate 241, which may be designed to allow the tray 221 to be deposited onto the offload conveyor 300.

As the basket 220 continues its downward movement, it passes through the unloading station grate 241, depositing the tray 221 partially onto the conveyor belt of the offload conveyor 300 as discussed above. This transfer may occur smoothly, with the tray 221 transitioning from the basket 220 to the conveyor belt without disrupting the contents of the food bag 222. The chain 223 may slow as each basket 220 approaches the grate to avoid disrupting the tray 221 or food bag 222, both when loading and unloading, and then reaccelerate between baskets.

In some cases, sensors may be incorporated into the offload conveyor 300 to detect the presence of a tray 221. These sensors may trigger various actions, such as adjusting the speed of the conveyor belt or alerting team members that an order is ready for pickup.

The sequence of images in FIGS. 10A-B demonstrates the seamless transition of food items from the transport system to the offload conveyor 300, showcasing the automated nature of the food handling process in this system. This efficient transfer contributes to the overall speed and effectiveness of the food delivery process in the high-capacity drive-through restaurant 100.

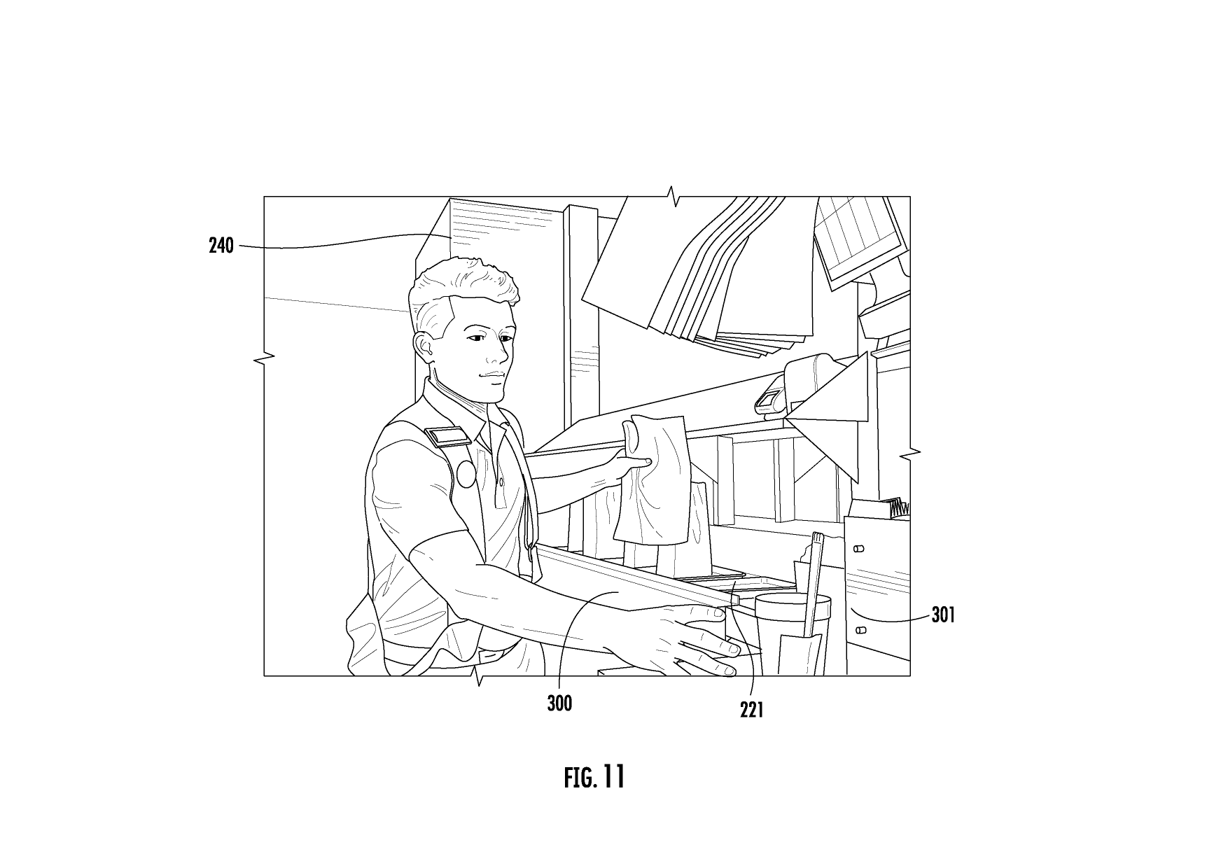

Referring to FIG. 11, an order t area is provided. In some aspects, the area may include various components designed to facilitate efficient order final assembly and delivery. For example, the unloading station 240 may be equipped with several display screens mounted above the offload conveyor 300. These screens may provide information or instructions to operators during the unloading process. In some implementations, the screens may display order details, customer information such as the type of car, or status updates to assist team members in efficiently managing the unloading and distribution of food items.

Above the offload conveyor 300, and shelf and/or one or more bins may be positioned. The shelf and bins can hold miscellaneous items for completion and of an order, such additional condiments, utensils, napkins etc. Given the length of the offload conveyor 300, it serves not only to offload the full trays supplied by the transport track, but also provides a staging platform from which teams members can view the order on the display screens to make final adjustments to each food order, such as the additional condiments and the like provided above the conveyor. As discussed, the conveyor belt can continually advance during this process, or make intermittent stops to provide for efficient and safe staging.

Adjacent to the offload conveyor 300, a drink station 301 is positioned to allow efficient fulfillment of the customers’ orders. The drink station 301 may be equipped for beverage preparation and dispensing. In some cases, the drink station 301 may include automated beverage dispensers, ice machines, straw dispensers and other equipment to facilitate efficient drink preparation. Alternatively, or in addition, a drink station could be position adjacent the loading station (e.g. in a kitchen on a second floor of the restaurant) such that drinks are placed on trays along with food orders and are then moved by the transport track to the offload conveyor.

Team members may interact with the various components of the staging area and drink station to finally assemble and deliver orders. In some aspects, a team member may retrieve food items from the offload conveyor 300, collect beverages from the drink station 301, and use the conveyor table 301 to combine these elements into complete orders. In other aspects, the food items are first grasped by the team member, immediately followed by the drink, and then handed to the drive-through customer by way of an open window door, as can be seen in FIG. 11.

The positioning of the offload conveyor 300, drink station 301, and conveyor table 301 may be arranged to minimize unnecessary movement and streamline the order assembly process. The design of this area allows for flexible operations. In some cases, multiple team members may work simultaneously in different zones, such as one retrieving food items from the offload conveyor 300 while another prepares beverages at the drink station 301. This configuration may enable efficient handling of varying order volumes and complexities. The team members can then hand deliver each order to a waiting customer's car in a quick and efficient fashion.

The use of trays is also beneficial here as the trays can securely support the customers’ orders, include liquids as discussed above, but also allow for efficient and error-free presentation of an order to a customer, including a correct combination of condiments, straws, napkins and the like, in addition to the food. For example, one team member may complete and check the final combination against an order ticket or order screen as assembled on one tray, while another team member may immediately thereafter run the food order and associated items to a waiting car. The presenting team member may separately grasp all of the items as shown in FIG. 11, or may carry the full tray to the car to provide more efficient and stable presentation directly to the customer. The team member can thereafter return the empty tray to the offload conveyor or the tray cart 400.

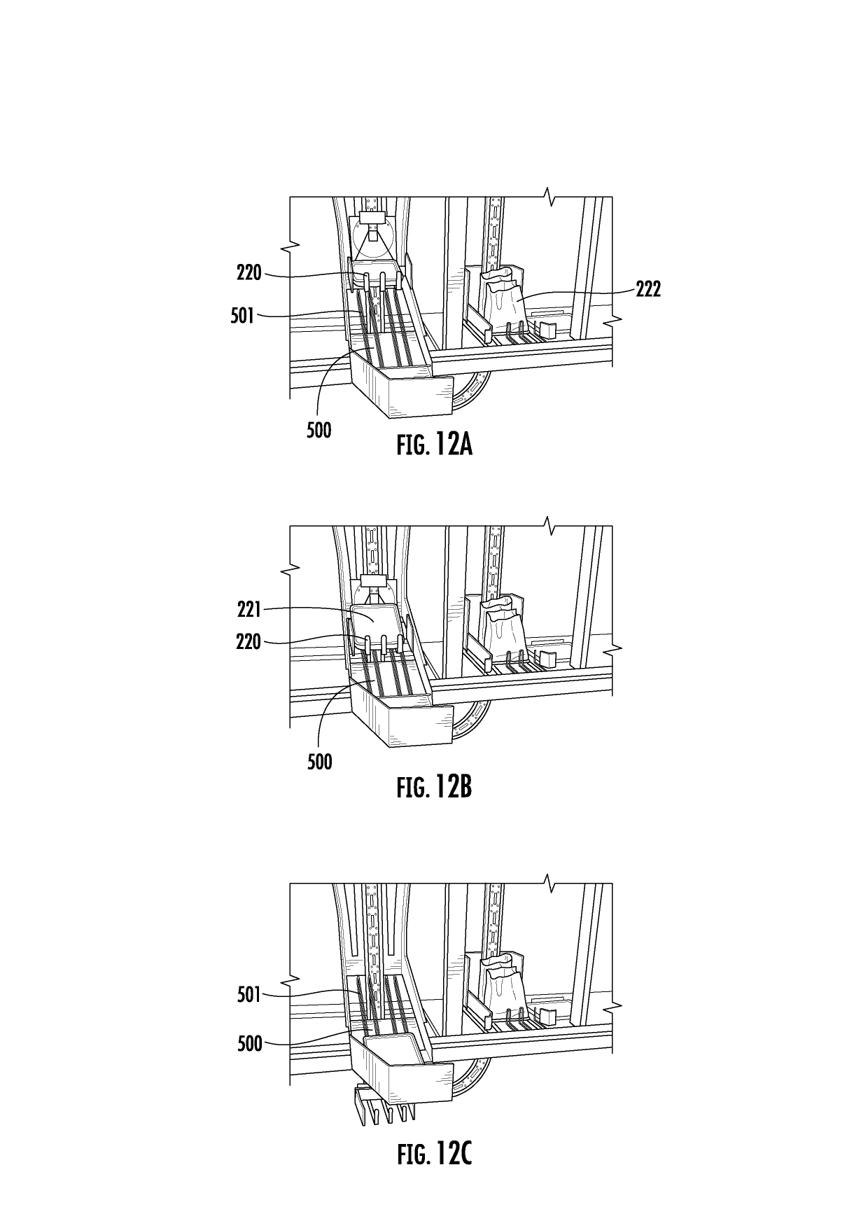

Referring to FIGS. 12A-C, an empty tray unload station 500 of the food transport system may be provided. In some aspects, the empty tray unload station 500 may comprise several components designed to facilitate the collection and management of empty trays 221.

The empty tray unload station 500 may include an empty tray unload grate 501. In some implementations, the empty tray unload grate 501 may be visible as a series of parallel bars. This grate 501 may allow empty trays 221 to be deposited and collected efficiently.

In some cases, the empty tray unload station 500 may serve as an alternative or in addition to the tray carts 400 for returning empty trays 221. The empty tray unload station 500 may provide a more automated approach to tray management compared to the manual collection in tray carts 400.

The sequence of images in FIGS. 12A-C demonstrates the process of depositing empty trays 221 into the empty tray unload station 500. In the first image, a basket 220 carrying a stack of empty trays 221 is positioned above the empty tray unload station 500. The second image shows the stack of trays 221 partially lowered into the station 500. In the final image, the trays 221 have been fully deposited into the empty tray unload grate 501 of the empty tray unload station 500.

In some implementations, when a number of empty trays 221 have been accumulated at the unloading station, a team member may place the stack onto an empty basket 220 heading back from the unloading station to the loading station. This process may allow for efficient recycling of empty trays 221 through the system.

The empty tray unload station 500 may be designed to automatically empty the stack of trays 221 from the basket 220, as shown in the successive images of FIGS. 12A-C. This automated unloading process may contribute to the overall efficiency of the tray management system.

In some aspects, sensors may be incorporated into the empty tray unload station 500 to detect when a certain number of trays 221 have accumulated. These sensors may trigger alerts to notify team members when it's time to transfer the accumulated trays 221 back to the loading station 230.

The empty tray unload station 500 may be positioned in a location that allows for easy access by team members while minimizing interference with other operations. In some implementations, multiple empty tray unload stations 500 may be incorporated into the system to handle high volumes of tray circulation.

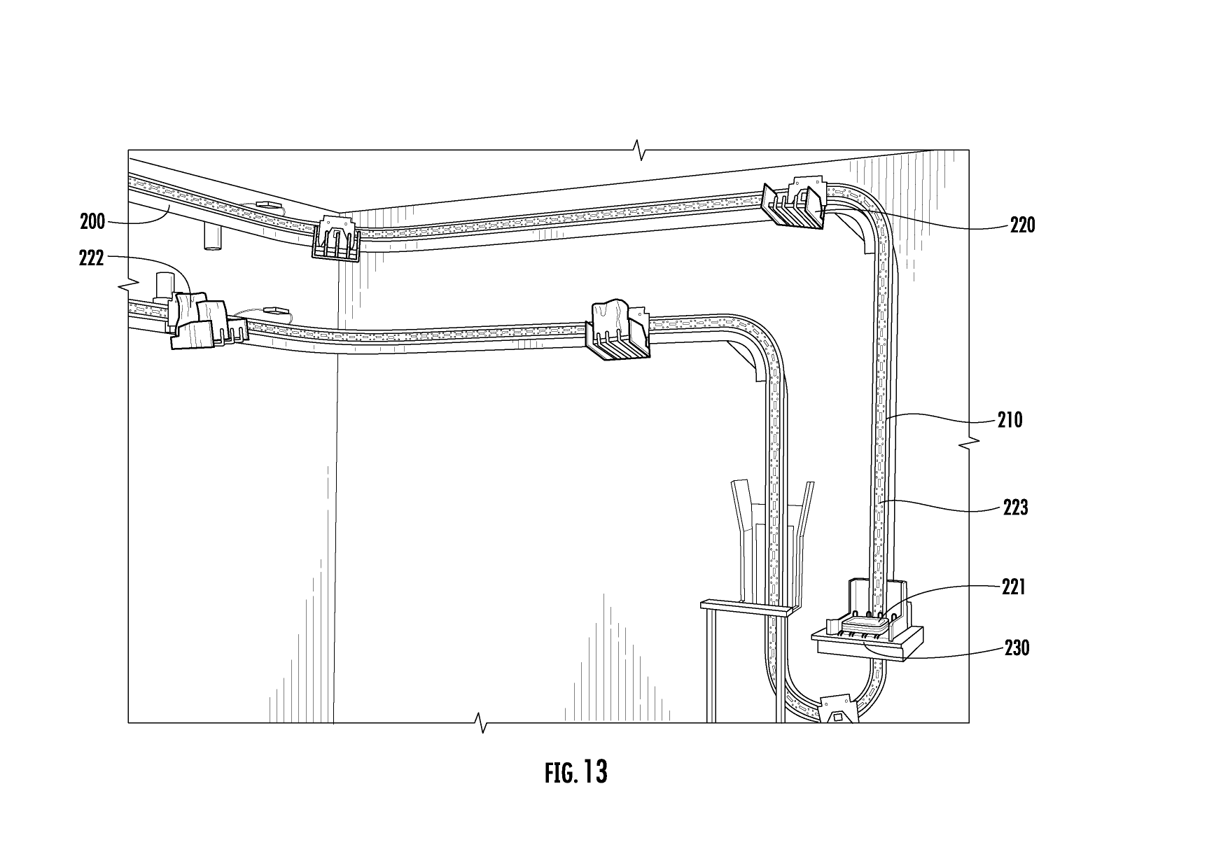

Referring to FIG. 13, the transport track 210 is shown forming a curvilinear path along the upper portion of the system. In some implementations, the transport track 210 may serve as the primary guide for the movement of baskets 220 through the system. The transport track 210 may be configured to accommodate various restaurant layouts, potentially including vertical and horizontal sections to efficiently move food items between different areas or levels of the facility.

Multiple baskets 220 are visible along the transport track 210. In some cases, the baskets 220 may be designed to hold food items during transport. Some baskets 220 contain food bags with customer orders ready for delivery.

While FIG. 13 shows the food transporter system 200 in an open configuration, in some aspects, the transport track 210 may be fully enclosed by ducts or enclosures. This enclosed configuration may serve multiple purposes, such as protecting team members from moving parts, maintaining food safety by shielding food items from environmental contaminants, and potentially controlling temperature and humidity within the transport system.

The food transporter system 200 may be designed to allow for efficient movement of food items from one area to another, potentially bridging different sections of a food service operation. In some implementations, the system may be capable of handling varying volumes of orders, with the ability to adjust speed or basket frequency based on demand.

In some aspects, the food transporter system 200 may incorporate sensors at various points along the transport track 210. These sensors may monitor the movement of baskets 220, detect any potential issues, and provide real-time data on system performance. This information may be used to optimize system operations and quickly address any maintenance needs.

The layout of the food transporter system 200 may be customizable to suit different restaurant configurations. In some cases, the transport track 210 may be designed with modular sections, allowing for easy installation and modification to accommodate changes in restaurant layout or operational needs.

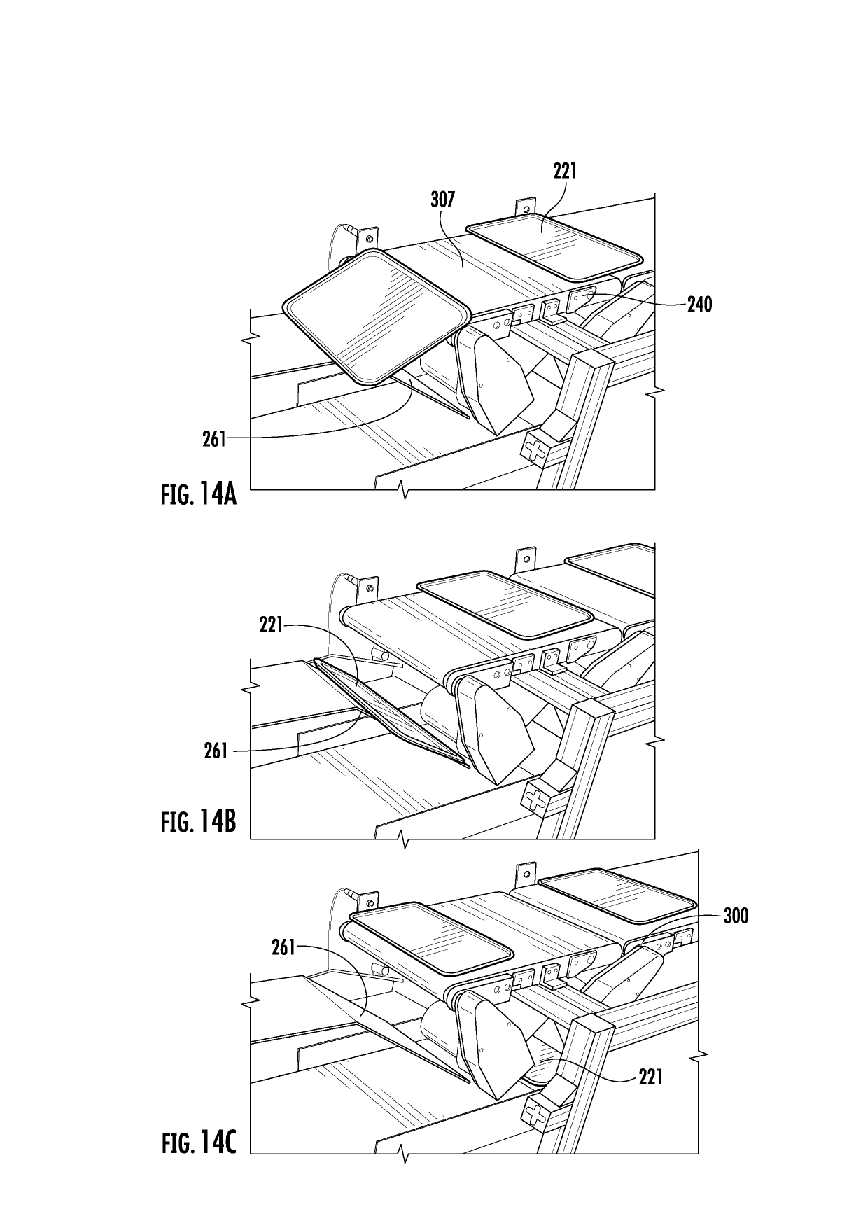

Referring to FIGS. 14A-C, the operation of an offload conveyor 300 in the food transport system is illustrated. In some aspects, the process may involve the transfer of trays 221 from the transport system onto the offload conveyor 300 and the subsequent collection of empty trays 221. The offload conveyor 300 may be configured to receive trays 221 from the unloading station 240 on a conveyor belt 307 and transport them forward.

The sequence of images demonstrate the process of transferring trays 221 from the offload conveyor 300. According to the illustrated embodiment, as the trays 221 reach the downstream end of the offload conveyor 300, they fall off the conveyor belt 307. The falling trays 221 may then strike the tray collector guide 261, which may be configured to position the trays 221 to fall in a desired orientation.

In some aspects, a lower conveyor may be positioned below the tray collector guide 261 and the offload conveyor 300. The trays 221 may fall onto this lower conveyor after being guided by the tray collector guide 261. From the lower conveyor, the empty trays 221 may be moved to a cart or to a stack for movement back to the loading station 230 as described above.

The system may be designed to handle various tray configurations and sizes. In some implementations, sensors may be incorporated along the offload conveyor 300 and tray collector guide 261 to monitor the movement of trays 221 and detect any potential issues.

The arrangement of the unloading station 240, offload conveyor 300, and tray collector guide 261 may be optimized for efficient tray handling and recycling. In some cases, this configuration may contribute to the overall efficiency of the food transport system by ensuring a steady supply of empty trays 221 for reuse in the loading process.

A number of implementations have been described. Nevertheless, it will be understood that various modifications may be made without departing from the spirit and scope of the disclosure. Accordingly, other implementations are within the scope of the following claims.

1. A food transport system for a restaurant using a plurality of trays for supporting food items for customers, the food transport system comprising: a transport track extending at least partly through the restaurant; a tensile member coupled to the track and being movable relative thereto; a plurality of baskets coupled to the tensile member and movable relative to the transport track at least partly through the restaurant; a loading station configured to load trays and food items on the trays onto the baskets; an unloading station configured to unload trays and food items on the trays from the baskets; and an offload conveyor positioned at the unloading station to receive trays and food items on the trays so that the food items can be received and provided to customers.

2. The food transport system of claim 1 further comprising a loading station grate positioned within the loading station, wherein the loading station grate is configured to support the trays as they are loaded onto the baskets.

3. The food transport system of claim 2, wherein the baskets comprise multiple elongate members configured to pass between parallel bars of the loading station grate to lift the trays.

4. The food transport system of claim 1, wherein the offload conveyor defines a plurality of sections including a receiving section adjacent the unloading station and an offloading section downstream thereof, and further comprising a tray cart configured to be positioned adjacent to the offloading section to collect empty trays after food items have been removed.

5. The food transport system of claim 4, wherein the offloading section and/or the tray cart comprise at least one sensor for determining that the tray cart is not in a correct position for receiving empty trays.

6. The food transport system of claim 1, wherein the offload conveyor defines a plurality of sections including a receiving section adjacent the unloading station and a staging section downstream thereof for facilitating final order assembly and delivery to the customers.

7. The food transport system of claim 1, wherein the unloading station further comprises an unloading station grate positioned within the unloading station, wherein the unloading station grate is configured to at least partially support the trays as they are offloaded from the baskets.

8. The food transport system of claim 7, wherein the offload conveyor is positioned adjacent to the unloading station grate to at least partially support the trays as they are offloaded from the baskets.

9. A restaurant comprising the food transport system of claim 1, wherein the restaurant comprises at least two stories, and wherein the transport track extends from at least one story to at least one other story.

10. The restaurant of claim 9, wherein one story comprises a kitchen and the loading station is positioned in the kitchen, and wherein another story comprises a ground floor and the unloading station is positioned on the ground floor.

11. The restaurant of claim 10, wherein a drive-through lane is positioned adjacent the unloading station.

12. The restaurant of claim 11, wherein the ground floor defines opposite sides and one or more drive-through lanes extend through the ground floor between the opposite sides thereof.

13. The food transport system of claim 1, wherein the loading station further comprises tray guides to assist in loading trays onto the baskets.

14. A method of transporting food items in a restaurant for customers using a plurality of trays, the method comprising: loading food items onto a tray at a loading station; placing the tray into a basket coupled to a transport track; moving the basket along the transport track to an unloading station; unloading the tray from the basket at the unloading station; and transferring the tray onto an offload conveyor adjacent to the unloading station.

15. The method of claim 14 further comprising: supporting the tray on a loading station grate within the loading station; and lifting the tray from the loading station grate using elongate members of the basket that pass between parallel bars of the loading station grate.

16. The method of claim 14 further comprising: moving the tray from the offload conveyor to a staging section of the offload conveyor;
removing food items from the tray; and moving a tray cart to a position adjacent to the offload conveyor.

17. The method of claim 16 further comprising stopping the offload conveyor when a tray reaches the staging section; and, finalizing a food order for a customer including one or more of: placing condiments, utensils, straws and/or napkins into a bag containing the food order, and preparing a drink for the customer.

18. The method of claim 14 further comprising:stacking the empty trays;placing a stack of empty trays onto a basket adjacent to the unloading station after a loaded tray has been removed from the basket;moving the basket with the stack of empty trays to a position adjacent to the loading station, and;removing the stack of empty trays from the basket before placing a tray and food items on the basket at the loading station.

19. The method of claim 16 further comprising sensing whether the tray cart is in a correct position for receiving empty trays from the offload conveyor.

20. The method of claim 19 further comprising stopping the offload conveyor after sensing the tray cart is not in the correct position.
